(19) United States
(12) Patent Application Publication
(10) Pub. No.: US 2009/0222530 A1
(43) Pub. Date: Sep. 3, 2009

(54) System and Method for Service Discovery in a Computer Network Using Dynamic Proxy and Data Dissemination

(75) Inventors: John Buford, Lawrenceville, NJ (US); Emre Celebi, Brooklyn, NY (US); Phyllis Frankl, Brooklyn, NY (US); Keith Ross, Brooklyn, NY (US); Gregory Perkins, Pennington, NJ (US)

Correspondence Address: GREGORY A. STOBBS, 5445 CORPORATE DRIVE, SUITE 400, TROY, MI, 48098, US

(73) Assignee: MATSUSHITA ELECTRIC INDUSTRIAL CO., LTD., Osaka (JP)

(21) Appl. No.: 11/990,414

(22) PCT Filed: Aug. 23, 2006
(86) PCT No.: PCT/US06/32866

§ 371 Date: Feb. 13, 2008

Related U.S. Application Data
(60) Provisional application No. 60/710,660, filed on Aug. 23, 2005.
(60) Provisional application No. 60/715,388, filed on Sep. 8, 2005.
(60) Provisional application No. 60/716,384, filed on Sep. 12, 2005.

(51) Int. Cl. G06F 15/16

(52) U.S. Cl. 709/217

(57) ABSTRACT

A service advertisement delivery system and method is useful in a data processing network. A broadcasting node receives service advertisements describing services offered by service providing network nodes. A datastore in communication with the broadcasting node stores a set of the service advertisements of the service providing network nodes. The broadcasting node broadcasts the set of service advertisements over a broadcast channel to service seeking network nodes receiving the advertisements over the broadcast channel.

### CROSS-REFERENCE TO RELATED APPLICATIONS

This application claims the benefit of U.S. Provisional Application No. 60/716,384, filed on Sep. 12, 2005. This application also claims the benefit of U.S. Provisional Application No. 60/710,660, filed on Aug. 23, 2005. This application further claims the benefit of U.S. Provisional Application No. 60/715,388, filed on Sep. 8, 2005. The disclosures of the above applications are incorporated herein by reference in their entirety for any purpose.

### FIELD

The present disclosure generally relates to automated service discovery, and relates in particular to a method of delivering service advertisements in a computer network.

### BACKGROUND

There are many service discovery mechanisms. Associated with these service discovery mechanisms are related mechanisms for service description, service advertisement, service notification, and service invocation. The ability of a node to describe, locate, receive events about, identify, and use a service in a networked environment is intrinsic to “service discovery”. Herein, we use “service discovery” to refer to the collective set of methods for service description, registration, notification, discovery, and invocation, unless stated otherwise.

As used herein, the following terms are explicitly defined as follows: (1) broadcast: a transmission to multiple, unspecified recipients; (2) data dissemination: diffusion for propagation of data; (3) service: also referred to herein as resource, a computational function or device resource packaged for use by remote nodes; (4) service description: information about a networked service such as type of service, name of service, attributes of service, location of service, and/or invocation of service, which may be stored in a document or at a service repository or at the node offering the service, may be broadcast or multicast by the node offering the service, and/or may be machine readable or human readable or both; (5) service advertisement: the publication of a service description, in whole or part, by the service offerer, for access by other nodes; (6) service discovery: retrieval or access of service advertisement by nodes other than the service offerer, including browsing, search by name, class, type and or service attributes; (7) service invocation: execution of a service over a computer network; (8) service notification: an event signaling change in the availability of a service; and (9) service composition: the definition of a new service using two or more existing services.

Service discovery and advertisement protocol is fundamental to service interoperability in networked consumer electronics (CE). Existing approaches have well-known limitations, and there is a need in the home network and personal area network (PAN) for a service discovery and advertisement protocol that provides security, group access control, enables node mobility, and allows all nodes to participate even in power standby mode. There is also a need for a service discovery and advertisement protocol to be selectively and securely propagated beyond the home network for services to be discovered and used by mobile peers, peers in mobile PANS, or peers otherwise outside the home network.

### SUMMARY

A service advertisement delivery system and method is useful in a data processing network. A broadcasting node receives service advertisements describing services offered by service providing network nodes. A datastore in communication with the broadcasting node stores a set of the service advertisements of the service providing network nodes. The broadcasting node broadcasts the set of service advertisements over a broadcast channel to service seeking network nodes receiving the advertisements over the broadcast channel.

Further areas of applicability will become apparent from the detailed description provided hereinafter. It should be understood that the detailed description and specific examples are intended for purposes of illustration only and are not intended to limit the scope of the present disclosure.

### BRIEF DESCRIPTION OF THE DRAWINGS

The drawings herein are intended for illustration purposes only and are not intended to limit the scope of the present disclosure in any way.

FIG. 1 is a graphical representation of power states of a node or its network adapter.

FIG. 2 is a block diagram illustrating a broadcasting node broadcasting advertisements to other, service seeking nodes.

FIG. 3 is a block diagram illustrating example information in an advertisement.

FIG. 4 is a block diagram illustrating an example set of advertisements in a broadcast.

FIG. 5 is a block diagram illustrating groups in broadcast of advertisements.

FIG. 6 is a block diagram illustrating two groups in an advertisement broadcast.

FIG. 7 is a block diagram illustrating network node states and state transitions.

FIG. 8 is a block diagram illustrating a service advertisements for specific groups of devices or peers being distributed in the broadcast channel alongside public service advertisements.

FIG. 9 is a block diagram illustrating groups in broadcast of advertisements, with symmetric keys being broadcast with public key encryption.

### DETAILED DESCRIPTION

The following description is merely exemplary in nature and is in no way intended to limit the present disclosure, application, or uses.

In data dissemination, one node broadcasts a repeating stream containing advertisements of other nodes. Any node listening to the stream can discover available services. Any node in a set of peer nodes can be selected as the broadcaster. The criteria for selection can include optimization of available resources. The frequency of repetition of the broadcast stream can be changed dynamically.

The broadcast can contain service advertisements in multiple formats, thus supporting a heterogeneous set of service advertisement and description formats. A node does not need to be online in order for its service to be advertised. Similarly a mobile node may move outside the range of the network while its service continues to be advertised. The broadcast stream can be organized to enable group access control.

The data dissemination system and method enables re-broadcasting and relaying, enabling distribution beyond a given access point. As mentioned above, in some embodiments, the data dissemination system and method allows nodes to go offline be ensuring that advertisements for its services will be periodically broadcast while the node is offline. Therefore, the power states of nodes are of some interest, and deserve some discussion.

In some systems, all subsystems are in the same power state at any given time. In other systems, subsystems such as network adaptor can be in a different power state than other subsystems. In the latter case, let the network adapter be a separate subsystem with separate power states. If the network adapter supports the service discovery protocol when the adapter is in the “on” state, then the power states apply to either case. Additionally, we assume the network adapter supports a remote wakeup mechanism in which another service-seeking node can request that the power standby node move to the “on” state. Alternatively, if the network adapter doesn't support such a remote wakeup mechanism, the node can periodically resume itself to handle pending service invocations.

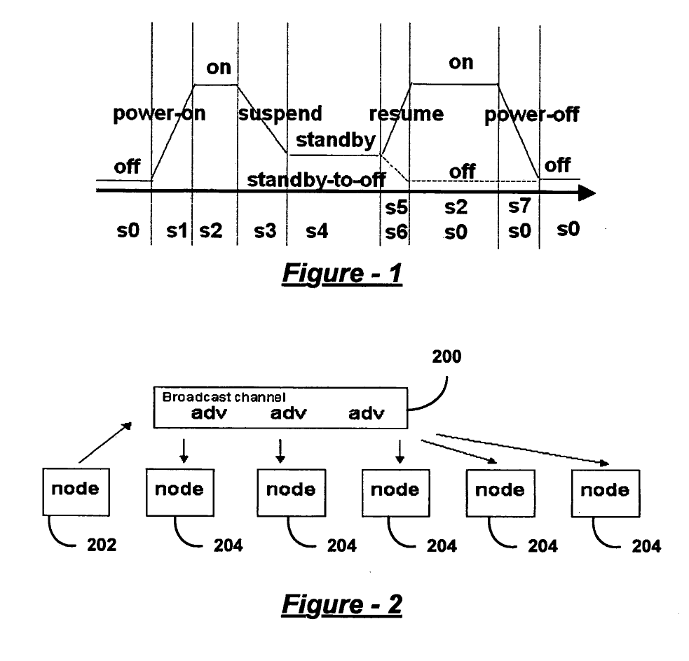

As shown in FIG. 1, there are at least eight power states of interest. A node can only perform service advertisement and discovery when it (or its network adapter subsystem) is in the on state (state s2). Nodes are in one and only one power state at any given time. We assume that services and their definitions are stable for relatively long intervals compared to power state changes. The data dissemination system and method is designed to accommodate the aforementioned power states, and also in view of design dimensions of service discovery protocols.

The design dimensions of service discovery protocols can be summarized as follows. Advertisements are transmitted in either pull or push modes (we treat relaying designs that might be used in mesh networks as a hybrid of push and pull). Advertisements are either proxied or non-proxied. The set of nodes that can act as proxies can be static or dynamic. For non-proxied systems, the service descriptions can be obtained from a dedicated server, a peer-to-peer index, or from the advertising node. Keeping in mind the aforementioned power states of network nodes, and the aforementioned design dimensions of service discovery protocols, we now turn our attention to describing particular capabilities of the data dissemination system and method that accommodate these power states and design dimensions.

Referring to FIG. 2, the data dissemination process can involve a broadcast channel on a data processing network in which a broadcasting node 200 caches service advertisements received from service providing nodes 202, and broadcasts one or more service advertisements to all other nodes 204 which receive the broadcast. Some nodes can provide some services, yet seek other services from other nodes. Thus, in some circumstances, node 202 can receive but ignore its own service advertisements. The broadcasting node 200 can be selected from among the nodes on the network, and can in some circumstances be a service providing node. Therefore, the broadcast stream of advertisements can included advertisements for services of other nodes 202, and advertisements for services of the broadcasting node 200. The broadcasting node 200 can repeat the broadcast and/or another node 204 can repeat the broadcast. The set of nodes receiving the broadcast can change at any time during the broadcast or between broadcasts. Attributes of the broadcast channel can vary over time including capacity, throughput, area coverage, signal strength, error rate.

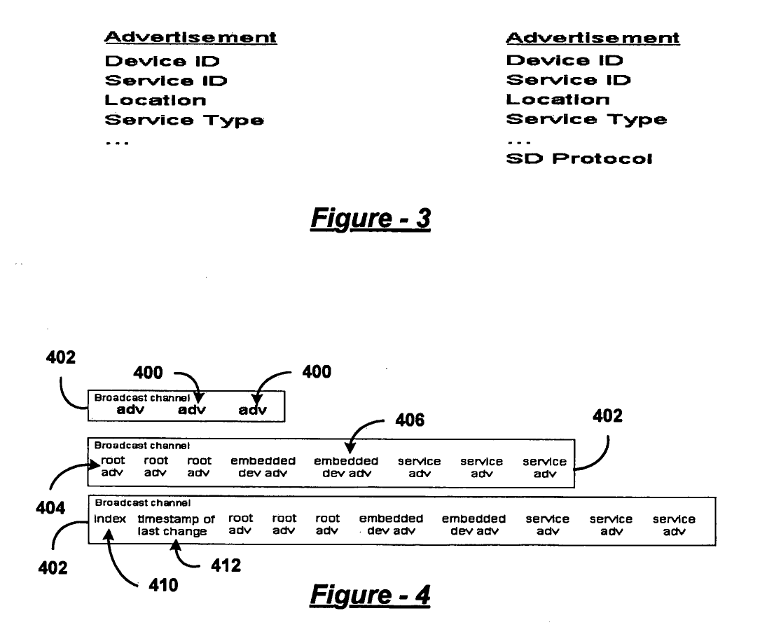

Referring now to FIG. 3, an advertisement can contain various types of information. Advertisements can contain resource location and description including name of resource, type of resource, address of resource, id of resource, format encoding and other information. Advertisements can be for nodes that are mobile and may move in or out of range of the broadcast channel. Advertisements can be for nodes that are on power suspend or standby or saving mode; some such nodes may be remotely resumable by active nodes which receive the advertisements; other such nodes may periodically resume themselves to handle service invocations.

Referring now to FIG. 4, different types of advertisements 400 can be included in a broadcast over a broadcast channel 402 in some embodiments. Examples include root device advertisement 404, embedded device advertisement 406, and service advertisement 408. In some embodiments the broadcast includes an index 410 showing the position of an advertisement in the stream of advertisements. In some embodiments the broadcast includes a timestamp 412 representing the time of the most recent change to the stream of advertisements. The index 410 in some embodiments contains both the position of the advertisement in the stream of advertisement and the timestamp indicating the time of the most recent change to the advertisement. The order of items in the stream can be determined by criteria for optimizing performance, efficiency, or other. The broadcast can be repeated according to various schedules, and the set of advertisements, ordering, and other aspects may change from time to time.

Other techniques can be used to indicate position in the stream, currency of the information, expiration of the advertisement, encoding of the advertisement, and protecting the privacy or security of the advertisement. The same advertisement can be included in multiple encodings. Different advertisements in a broadcast can follow different formats and encodings.

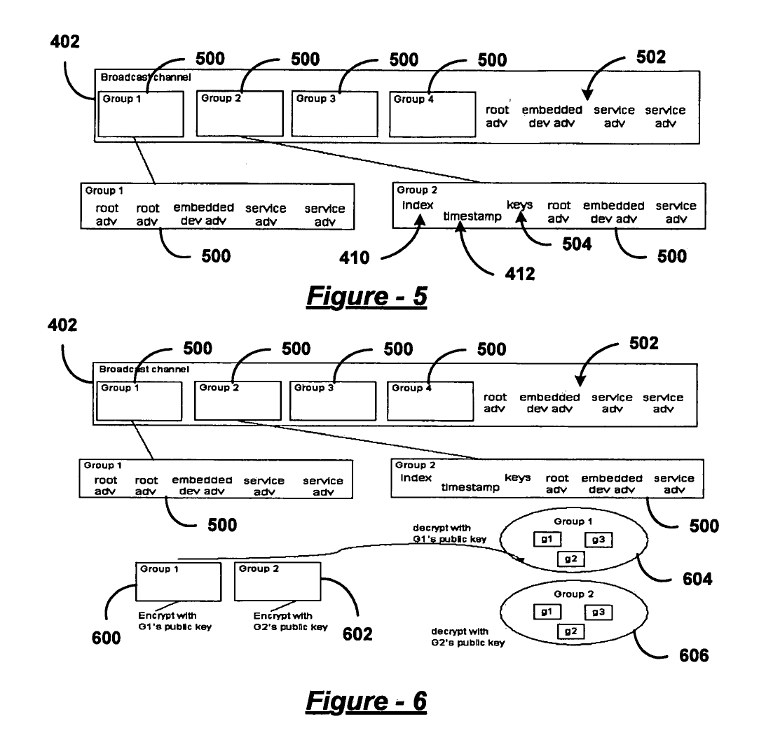

Referring generally to FIGS. 5 and 6, nodes providing resources can be members of one or more groups 500 in which the use of the resource is only available to nodes which are members of that group 500. The broadcast channel 402 can be organized by group 500. Broadcasts can include both grouped advertisements and ungrouped advertisements 502. Each group 500 can have an index 410, timestamp 412, encoding keys 504, and other group information in the group portion of the broadcast. The overall broadcast can also have an index, timestamp, and encoding keys.

Referring now particularly to FIG. 5, a stream of advertisements is organized by groups 500. In some embodiments, the stream includes both groups 500 of advertisements and ungrouped advertisements 502. The stream can include an index of the position of each group in the stream and timestamp indicating the time of the most recent change to the contents of the group advertisement stream. The index can also include position and timestamp entries for ungrouped advertisements. The order of advertisements in a group can be determined by criteria for optimizing performance, efficiency or other. The order of items in the stream can be determined by criteria for optimizing performance, efficiency, or other. Groups and advertisements can be encrypted, signed, hashed, or in the clear. If encrypted, signed, or hashed, a single function and key may be used for all groups and advertisements or may vary by group and advertisement.

Referring now particularly to FIG. 6, two groups 600 and 602 in an advertisement broadcast, each encrypted with a different key, can be received by nodes 604 and 606 which belong to group 1 and group 2 respectively. These nodes are able to decrypt the corresponding group advertisements. The group data can be encrypted so that only nodes which are members of the group can access it. There are various means by which groups of nodes can be created and keys for securely exchanging group data may be distributed, updated, revoked, and otherwise managed. Changes to the group advertisement can be done by the node which is the group owner or by any node which is a member of the group, depending on the group policy.

It should be readily understood from the foregoing description that the system and method of delivering advertisements in a data processing network uses a broadcast channel in which a node broadcasts one or more advertisements to other nodes which receive the broadcast, in which the advertisements represent resources of more than one node. It should also be readily understood that the broadcasting node can be statically determined or dynamically determined. Further, it should be understood that the broadcasting node can cache advertisements for other nodes, and that the set of receiving nodes can change. Still further, it should be readily understood that the broadcasting node can broadcast continuously, periodically, or some other schedule, or can broadcast on demand or by subscription. Moreover, it should be understood that the set of advertisements can change based on the node population or other criteria, and that the node broadcasting can change based on performance, efficiency, reliability, load distribution, availability of other nodes, and other criteria.

It should be noted that the term “broadcast channel” is not meant to be a specific type of broadcasting or physical media channel in some wireless technology, but rather it is a pre-determined network mechanism by which one node can transmit simultaneously to all nodes connected to the medium.

Relaying from one broadcast channel to another can be accomplished in various ways. For example, a receiving node in one broadcast can forward the broadcast stream to another node which is broadcasting in another channel to another population of nodes. Forwarding can be on a different interface or the same interface. Also, there can be one or more intermediate nodes in the relay chain, and these intermediate nodes can merge broadcast content from other nodes. Further, a node can relay to multiple destination broadcast nodes by multicasting the broadcast stream to those nodes. Still further, the relaying can be constrained by a time-to-live or other distance limiting method. Further still, a roaming node can cache advertisements received in one or more broadcasts and while roaming re-broadcast elements of the cache in other environments for other nodes to receive. These nodes can in turn cache one or more of such advertisements and re-broadcast them as they roam.

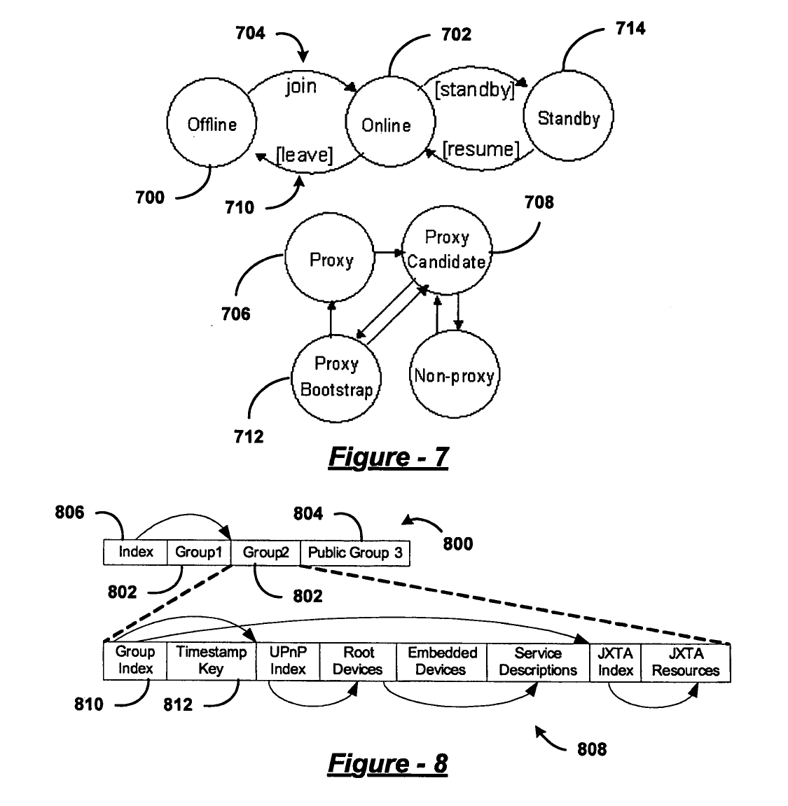

Turning now to FIG. 7, some embodiments can take the form of a power-conserving service discovery protocol, or be employed as part of such a protocol. Such a protocol is herein after referred to as “Sleeper.” Regarding Sleeper node states and state transitions, online nodes can be in one of four states, including join, standby, resume, and leave. For example, an offline or disconnected node 700 moves to online state 702 and broadcasts a join message 704 which includes its advertisements and their popularity metrics. The current proxy node 706 caches these advertisements. Any proxy-candidate node 708 may also cache these advertisements. An online node 702 can broadcast a leave message 710 prior to going offline; if a leave message is not transmitted, advertisements may be purged from the proxy and other online nodes' cache by expiration. Transitions to/from standby state may also be indicated by broadcast messages.

Every node initially goes online as a non-proxy node 706. A proxy-capable node becomes a proxy-candidate node 708. There may be more than one proxy-candidate at any time. When no proxy is detected, for example by absence of a service advertisement broadcast, or a proxy vacates, the first proxy-candidate to issue the proxy bootstrap 712 becomes the proxy node 706. A vacating proxy node can transfer its cache to the new proxy, or the new proxy node can collect advertisements from online nodes through the bootstrap 712. Nodes which are in standby state 714 during the proxy change can be polled by the new proxy after the standby node transitions to online.

A proxy continues to collect advertisements from joining nodes, and purges advertisements due to expiration or leave messages. A proxy periodically pushes advertisements for popular services; detection of an absent proxy is triggered by missed broadcasts or by explicit probing by other nodes.

Nodes self-select to be proxy candidates and can broadcast their capabilities to other nodes when transitioning to the proxy-candidate state. In this way each candidate may rank itself with respect to the capabilities of the other candidates. This ranking is used by the node to determine when it issues the bootstrap request after a proxy vacates or its absence is detected, so that higher capability nodes will be favored to be the next proxy.

In Sleeper, service advertisements and indices are characterized by various factors. For example, these factors include push, pull, and service popularity. Additional factors include federated discovery, meta service discovery, location-based discovery, taxonomic based discovery, and push structure.

Regarding push, pull, and service popularity, the proxy pushes a set of advertisement indices and popular advertisements on a periodic basis. The broadcast includes: (1) federated discovery: index entries and advertisements in various formats (Bluetooth SDP, UPnP, SDP); (2) meta-discovery: index entries and advertisements for other service discovery methods; (3) location-based discovery: index entries and advertisements according to geographic position; and/or (4) taxonomic-based discovery: index entries and advertisements according to a taxonomic classification. Service popularity is defined as the average number of service invocations per node in a recent time window. Note that service popularity can be different than service advertisement popularity. It is straightforward for a node to maintain service invocation counts by time period. These measures can be furnished to the proxy when the node joins the network. The proxy can then includes service advertisements for the most popular services in the push advertisement. Other advertisements can be discovered by explicit pull from the non-proxy nodes. Any pull response can be broadcast to all nodes.

Regarding federated discovery, Sleeper accommodates multiple service advertisement formats that are likely to co-exist in future network environments. By being neutral with respect to format of the advertisement, Sleeper can be used, for example, to propagate legacy protocols beyond the transport boundaries that occur for protocols such as SSDP and Bluetooth SDP. Service invocation in such cases can rely on gateways to convert between different service discovery protocols or to connect to different service discovery domains.

Regarding meta service discovery, there are many different service discovery mechanisms that can co-exist in a given environment. Conceptually, a service discovery mechanism is a special type of service used to locate other services. Herein, the discovery of a service discovery mechanism is referred to as meta service discovery. Sleeper allows other service discovery mechanisms to be advertised and discovered.

Regarding location-based discovery, each service can be referenced by location. This reference capability is useful if a mobile node wants to use a service in a particular context. One can use the following approach to index locations. In general, a location can be specified according to street address, landmark, or latitude-longitude (LL). Street address and landmarks can be converted to a corresponding LL. In turn, LL can be normalized to decimal format and aligned to the nearest grid point. The resulting grid point can be directly indexed. The grid alignment approach considerably simplifies lookup.

Regarding taxonomic based discovery, there is a growing interest in semantic service discovery. For example several semantic service description languages have been defined including DAML-S/OWL-S, WSMO, and DIANE Service Description (DSD). In addition to a service functional description that is found in existing service description languages such as WSDL or UPnP templates, semantic service description typically includes a shared ontology and a reasoning mechanism. Discovery is typically through a matchmaking mechanism.

Due to the complex nature of semantic service advertisement and matchmaking algorithms, Sleeper uses a two phase process. Service descriptions are classified according to a taxonomy. The most relevant taxonomy concepts are used to index the service advertisement. When a taxonomic match is obtained during service discovery, the second phase of discovery involves sending the service request to the node(s) matching the taxonomy. These nodes then perform the appropriate matchmaking step.

There are several service-specific taxonomies (Table 1) for estimating the size of the taxonomy. Using a semantic overlay for large-scale peer-to-peer systems, each concept in a taxonomy has a unique id based on the path to its position in the taxonomy from a root node. This ID is used by nodes in Sleeper to have a common reference for the same concept. Nodes can store those fragments of the complete taxonomy for concepts of interest.

TABLE 1
Example service taxonomies and number of associated concepts

| Taxonomy | # Concepts |
|---|---|
| eCl@ss | 25,658 |
| eOTD | 58,970 |
| RNTD | 789 |
| UNSPC | 20,789 |

Regarding push structure, the organization of the push structure is shown in Table 2. Each index can be made up of 2 or more columns.

TABLE 2
Push structure

| Segment | Organization |
|---|---|
| Top index | Sub index name - position in channel |
| Federated index | Service name - protocol name |
| Meta discovery index | Protocol id - position in channel or id at proxy |
| Location-based index | Grid position - position in channel or id at |
| | proxy |
| Taxonomic index | Category id - position in channel or id at proxy |
| Service advertisements | List of popular advertisements |

Securing the service advertisements in Sleeper can be accomplished using property certificates and trust establishment. A property certificate is a PKI certificate that binds one or more personal attributes or descriptors to a public key, rather than an identity. X.509 certificates can be used as property certificates. The ‘Subject X.500 Name’ field can be used to identify the certificate as a property certificate. Attribute(s) can then be listed in the X.509 extensions.

Peer trust mechanisms based on credential-based trust have the significant short coming that they may expose sensitive properties, credentials, or policies during the trust negotiation step. For example, some credentials must be freely available on at least one side of a trust negotiation. In addition, credentials are exposed even if a trust negotiation fails.

We have previously developed a solution to this limitation of property-based trust negotiation which uses a secure trust negotiation agent (STNA) on each peer. Because of this solution, disclosure of credentials need not take place because the exchange of credentials for negotiation are separate from the disclosure of credentials to the end party. The STNAs can confirm that the necessary credentials exist to satisfy the trust policy, without disclosing the actual value of the credentials to the end party, and any such disclosure can be subject to a separate policy.

In addition, because a property-based trust negotiation can require the validation of multiple certificates, we have introduced the concept of a meta-certificate which a peer may present to show that a mutually trusted third-party has validated its property certificates. An STNA may ignore the meta-certificate or use it in combination with validation of selected certificates.

In general, property-based trust negotiation is vulnerable to attacks to gain information about private credentials such as: (1) probing using multiple negotiations; and (2) inference through specific construction of policies. To counteract the probing attack, the peer's STNA can retain a history of its negotiations and place a limit on the number of negotiations that are permitted with any peer. To counteract credential inference, limiting the number of attributes and properties being tested by the negotiating peer's policies is desired. Avoiding negotiations in which policies prescribe specific sources of credentials is preferred (negotiation policy is exchanged before doing the negotiation).

Sleeper nodes can establish mutual trust using a trust negotiation mechanism. Assuming that each peer caches public keys for certificate issuers that are relevant to its peer trust policies, then peer trust establishment can be performed without a centralized authority.

In overview of the security design, we are concerned with protecting the privacy of service advertisements and descriptions, authentication of service advertisements, and secure distribution and updating of keys for service invocation. A set of peers that satisfy trust requirements are a group G={Gid, O, pi, C}, where Gid is the name of the group, O is the owner of group, pi is a potentially empty set of peers which are members of the group, and C is the set of criteria for group membership. The owner O may be a group member depending on C.

A component of the security design is a privacy-preserving advertisement. Each peer manages the groups it owns using a Group Service (GS). If a GS is public, it can be advertised and discovered like any other peer service. If it is private, then other peers discover it using out-of-band means such as configuration. A peer p uses a GS to manage those groups G where p ⊖ GS.G.O.

For any group, let J be the join operation and L be the leave operation, where L includes peer initiated and administered removals. During the join operation, a peer presents property certificates which satisfy the group criteria C. A peer which has successfully completed the sequence (JL)*J [symbol] L is a member of that group.

A service discovery mechanism is privacy preserving if a peer can discover the service description using the mechanism only if the peer satisfies the criteria C. Thus a mechanism which only distributes service descriptions to peers which are members of group G with criteria C is privacy preserving.

Given a GS with group G, then privacy preserving service discovery mechanisms include: (1) the GS caches private service descriptions for each group and allows only group members to retrieve them; and (2) the GS publishes encrypted service descriptions which can only be decrypted by members of G, and these encrypted service descriptions are broadcasted to all connected peers, but can only be decrypted by group members.

Turning now to FIG. 8, in Sleeper, the broadcast channel 800 is divided into group-specific service advertisements 802 and a sequence of public service advertisements in a public group 804. It can include a group index 806 for the broadcast channel, with ungrouped advertisements being placed in the public group 804. Therefore, a peer can offer a private service to a group of peers without being a member of that group. Each group's advertisements 808 can be separately encrypted and can contain indices 810 and timestamps 812 for advertisement aging.

Authentication of service advertisements is another feature of Sleeper. The purpose of authenticating a service advertisement is to verify that the source of the service description is the specified peer. Authenticating a service advertisement validates that the service interface is provided by a peer, but doesn't imply trust in the implementation of the service or the service offering peer.

A service description is digitally signed by the service providing peer. A peer can verify the signature using the public key of the peer. Trust in the service implementation and/or service offering peer may be influenced by factors such as: (1) which entity's identity is used on the public key of the peer; (2) is the public key signed by a trusted root authority; (3) does the service offering peer satisfy criteria for trust confirmed through a property-based trust negotiation; (4) and the reliability and uniqueness of the peers identity in the service overlay.

Sleeper uses the property-based trust negotiation method described earlier to establish peer trust prior to service invocation. This allows the service invoking peer to specify trust criteria which may constrain the entity's identity on the peers public key and the certificate chain on any certificates. Because Sleeper is a federated service discovery protocol, it relies on peer identity mechanisms in underlying service overlays.

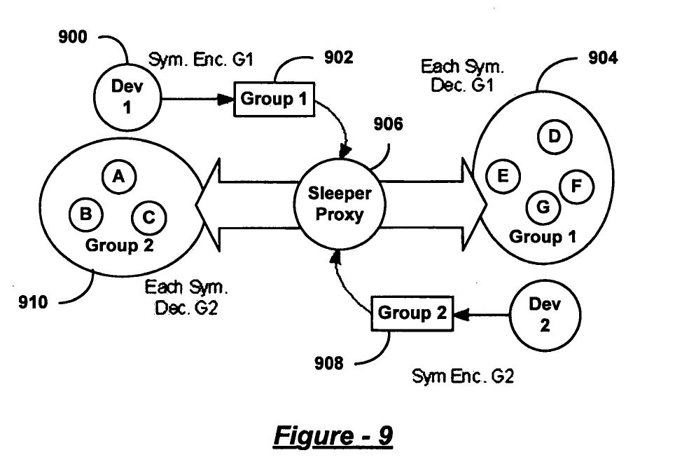

Yet another feature of Sleeper is key distribution for service invocation. Referring to FIG. 9, consider that a device 900 joins a group 902 and wishes to distribute its service advertisements to member nodes 904 of the group 902. In this case, it uses its group digital certificate to set up a secure connection with the GS, and signs the advertisements before transmitting them to the GS. In particular, groups in broadcast of advertisements broadcast symmetric keys with public key encryption. The GS, for example, has a symmetric key that has previously been generated and distributed to the group members. This key is periodically replaced, for example, when a device leaves the group. The set of GS advertisements and other information such as indices and timestamps are organized by the GS and encrypted using the symmetric key. The result is forwarded to the proxy for inclusion in the broadcast or to other GSes if this group is a member of other groups.

Subsequently, the Sleeper proxy 906 transmits this group's service advertisements along with other advertisements it has obtained. It may add a group id index to the broadcast in order for group members to locate their group's data in the broadcast. Any device which is a current member of the group will have the symmetric key and, be able to decrypt the GS advertisements.

FIG. 9 shows two groups 902 and 908 in an advertisement broadcast, each encrypted with a different key, received by nodes 904 and 910 which belong to group 1 and group 2 respectively, which are able to decrypt the corresponding group advertisements. To reduce instantaneous key management overhead, symmetric keys are created and distributed before their use time.

Regarding the GS, in particular, we use a GS to manage the formation of peer groups. Any peer can offer the GS. The GS can be advertised as a public service for other peers to discover. It provides the following capabilities: (1) group's lifecycle; (2) unique identifiers; (3) peers, devices and resources can be registered as a group member; (4) a group can be a member of another group; (5) group membership can be securely controlled, including removal of an existing group member; and (6) encryption/decryption keys can be distributed to members of the group.

Joining the group can be accomplished using a secure connection with digital certificates. For example, when a peer joins a group, it can set up a secure connection to the peer administering the group (hereafter GS) and authenticate itself to the GS. For each group managed by the GS there is a membership criteria. The membership criteria are some combination of properties and validation criteria, such as expressed in this grammar:

expr ::= property_name op value [validation]
expr ::= not expr [validation]
expr ::= expr or expr
validation ::= validated_by { named-issuer |

subject | peer | topCA | trustedCA | any
}

op ::= none | = | <> | <= | >= | < | > |

one_of | matches

property_name ::= *
value ::= number | string | regexp

If membership is based on identity, the device must present an identity certificate which the GS can validate. If membership is based on properties of the peer, then the appropriate property certificates are presented as in existing trust negotiation systems. The GS validates the property based certificates in the same manner as for identity certificates.

The GS issues a digital certificate to the joining device. This certificate is used in communication between the GS and the device to securely distribute symmetric session keys used for the Sleeper broadcast and for the device to send its service advertisements to the GS. This certificate is revoked when the device leaves the group.

Leaving the group can be accomplished in more than one way. For example, a peer can leave a group by explicit request or can be removed by the group owner. The GS flushes service advertisements for this peer from its cache, and revokes the digital certificate previously issued to the peer. It generates a new symmetric key and transmits this to each remaining group member. It re-encrypts the remaining service advertisements along with indices, timestamps, and other information. It then forwards this to the Sleeper proxy to use in place of the previous set of service advertisements.

It should be noted that group membership transitions are expected to be relatively infrequent with respect to service advertisement broadcasts. Nevertheless, very large groups might have relatively frequent re-encryption actions even with low frequency membership changes. In this case, a sequence of membership changes might be cached for a specific period of time before a re-encryption update is propagated to group members and the proxy.

Further, a receiving node may not require an updated symmetric key until it is ready to discover or invoke a service. This lazy mode permits the GS to provide the symmetric key on demand rather than through push, potentially gaining efficiency.

Distribution of service invocation keys can occur dynamically in response to changes in group membership. After a node receives a service advertisement, it may invoke the service. Several steps may be needed in the protocol such as retrieving the service description and downloading and installing a client stub for the service.

Authorization for invoking a service can be based on group membership. The authorization key can be included in the encrypted service advertisement bundle for the group. When a group membership change occurs, a new key is generated and distributed to the group members in the next Sleeper broadcast.

What is claimed is:

1. A service advertisement delivery system for use in a data processing network, the system comprising:
a broadcasting node receiving service advertisements describing services offered by one or more service providing network nodes;
a datastore in communication with the broadcasting node, the datastore storing a set of the service advertisements of the service providing network nodes; and
a broadcast channel in which the broadcasting node broadcasts at least part of the set of service advertisements to service seeking network nodes receiving the advertisements over the broadcast channel.

2. The system of claim 1, wherein the service advertisements broadcast over the broadcast channel represent resources of more than one network node.

3. The system of claim 2, wherein the service advertisements broadcast over the broadcast channel represent resources of at least two of the service providing network nodes.

4. The system of claim 2, wherein the service advertisements broadcast over the broadcast channel represent at least one resource of at least one of the service providing network nodes, and at least one resource of the broadcasting node.

5. The system of claim 1, wherein the broadcasting node broadcasts continuously, periodically, by a schedule, on demand, or by subscription.

6. The system of claim 1, wherein the broadcasting node is also a service providing network node, and the service providing network nodes mutually cooperate to dynamically select the broadcasting node from among at the service providing network.

7. The system of claim 6, wherein the service providing network nodes select the broadcasting node according to criteria seeking optimization of available resources.

8. The system of claim 1, wherein the broadcasting node modifies broadcasting of the service advertisements based on at least one of performance, efficiency, reliability, load distribution, or availability of other nodes.

9. The system of claim 1, wherein the broadcast channel is a pre-determined network mechanism by which one node can transmit simultaneously to all nodes connected to a network medium.

10. The system of claim 1, wherein at least one of the network nodes relays service advertisements from one broadcast channel to another.

11. The system of claim 10, wherein the network node is a receiving node in one broadcast that forwards the broadcast to another node which is broadcasting in another channel to another population of nodes.

12. The system of claim 10, wherein the network node is an intermediate node in a broadcast relay chain that merges broadcast content received from other nodes.

13. The system of claim 10, wherein the network node relays to multiple destination broadcast nodes by multicasting a broadcast stream to the multiple destination broadcast nodes.

14. The system of claim 10, wherein the network node constrains relaying to a time-to-live.

15. The system of claim 10, wherein the network node is a roaming node that stores advertisements received in one or more broadcasts and, while roaming, re-broadcasts stored advertisements in other environments for other nodes to receive.

16. The system of claim 1, wherein the broadcasting node broadcasts service advertisements in multiple formats, thus supporting a heterogeneous set of service advertisement and description formats.

17. The system of claim 1, wherein the broadcasting node broadcasts service advertisements for a service providing node that is offline.

18. The system of claim 1, wherein the broadcasting node organizes a broadcast stream of the service advertisements to enable group access control.

19. The system of claim 18, wherein the broadcasting node provides indices that can be used to provide quick location of an advertisement in the stream.

20. The system of claim 18, wherein the broadcasting node provides timestamps that can be used to show when an advertisement was last changed or made.

21. The system of claim 1, wherein the broadcasting node classifies service descriptions according to a taxonomy, in which most relevant taxonomy concepts are used to index service advertisements.

22. The system of claim 21, wherein the broadcasting node, upon obtaining a taxonomic match during service discovery, sends a service request to one or more service providing nodes matching the taxonomy, and allows these nodes to then perform appropriate matchmaking steps.

23. The system of claim 1, wherein the broadcasting node allows other service discovery mechanisms to be advertised and discovered.

24. A method of delivering service advertisements in a data processing network:
receiving, at a broadcasting node, service advertisements describing services offered by one or more service providing network nodes;
storing, at the broadcasting node, a set of the service advertisements of the service providing network nodes;
using a broadcast channel in which the broadcasting node broadcasts at least part of the set of service advertisements to service seeking network nodes receiving the advertisements over the broadcast channel.

25. The method of claim 24, wherein the service advertisements broadcast over the broadcast channel represent resources of more than one network node.

26. The method of claim 25, wherein the service advertisements broadcast over the broadcast channel represent resources of at least two of the service providing network nodes.

27. The method of claim 25, wherein the service advertisements broadcast over the broadcast channel represent at least one resource of at least one of the service providing network nodes, and at least one resource of the broadcasting node.

28. The method of claim 24, wherein the broadcasting node broadcasts continuously, periodically, by a schedule, on demand, or by subscription.

29. The method of claim 24, further comprising dynamically selecting the broadcasting node from among at least one of the service providing network nodes or the service seeking network nodes.

30. The method of claim 29, further comprising selecting the broadcasting node according to criteria seeking optimization of available resources.

31. The method of claim 24, further comprising modifying broadcasting of the service advertisements based on at least one of performance, efficiency, reliability, load distribution, or availability of other nodes.

32. The method of claim 24, wherein the broadcast channel is a pre-determined network mechanism by which one node can transmit simultaneously to all nodes connected to a network medium.

33. The method of claim 24, further comprising relaying service advertisements from one broadcast channel to another.

34. The method of claim 33, wherein the relaying is accomplished by a receiving node in one broadcast forwarding the broadcast to another node which is broadcasting in another channel to another population of nodes.

35. The method of claim 33, further comprising, at an intermediate node in a broadcast relay chain, merging broadcast content received from other nodes.

36. The method of claim 33, further comprising relaying to multiple destination broadcast nodes by multicasting a broadcast stream to the multiple destination broadcast nodes.

37. The method of claim 33, further comprising constraining the relaying to a time-to-live.

38. The method of claim 33, further comprising storing advertisements received in one or more broadcasts at a roaming node and, while roaming, re-broadcasting stored advertisements in other environments from the roaming node for other nodes to receive.

39. The method of claim 24, further comprising broadcasting service advertisements in multiple formats, thus supporting a heterogeneous set of service advertisement and description formats.

40. The method of claim 24, further comprising broadcasting service advertisements for a service providing node that is offline.

41. The method of claim 24, further comprising organizing a broadcast stream of the service advertisements to enable group access control.

42. The method of claim 41, wherein organizing the broadcast stream includes providing indices that can be used to provide quick location of an advertisement in the stream.

43. The method of claim 41, wherein organizing the broadcast stream includes providing timestamps that can be used to show when an advertisement was last changed or made.

44. The method of claim 24, further comprising classifying service descriptions according to a taxonomy, wherein most relevant taxonomy concepts are used to index service advertisements.

45. The method of claim 44, further comprising, upon obtaining a taxonomic match during service discovery, sending a service request to one or more service providing nodes matching the taxonomy, and allowing these nodes to then perform appropriate matchmaking steps.

46. The method of claim 24, further comprising allowing other service discovery mechanisms to be advertised and discovered.
